(19) United States
(12) Patent Application Publication
(10) Pub. No.: US 2015/0339663 A1
(43) Pub. Date: Nov. 26, 2015

(54) METHODS OF PAYMENT TOKEN LIFECYCLE MANAGEMENT ON A MOBILE DEVICE

(71) Applicant: MasterCard International Incorporated, Purchase, NY (US)

(72) Inventors: Anthony Lopreiato, Avon, CT (US); John Mwangi, White Plains, NY (US)

(73) Assignee: MasterCard International Incorporated, Purchase, NY (US)

(21) Appl. No.: 14/283,937

(22) Filed: May 21, 2014

(51) Int. Cl. G06Q 20/36; G06Q 20/32

(52) U.S. Cl. CPC G06Q 20/3678; G06Q 20/3674; G06Q 20/3278

(57) ABSTRACT

A method includes maintaining a token database in a computer system, where the token database maps tokens to primary account numbers (PANs) for payment card accounts. The method further includes storing a respective entry in the token database for a token, with the token being mapped by the respective entry to a respective PAN and the respective PAN identifies a payment card account that belongs to a cardholder who uses a mobile device. The method also includes provisioning the token to the mobile device and determining at a subsequent point in time that a lifecycle event has occurred or will soon occur with respect to the token. In addition, the method includes updating the respective entry for the token in the token database in response to determining that the lifecycle event has occurred.

### BACKGROUND

In payment systems it is a significant concern that primary account numbers (PANs) be protected from access by wrongdoers. One important initiative to prevent unauthorized access to PANs involves “tokenization.” Tokens have been defined as “surrogate values that replace [PANs]” in part of a payment system.

According to one use case set forth in the Payment Token Interoperability Standard (issued by MasterCard International Incorporated (the assignee hereof), Visa and American Express in November 2013), a mobile device with NFC (Near Field Communication) capabilities is provisioned with a token. At the point of sale, the mobile device may pass the token and related information via NFC to the merchant's POS (point of sale) terminal. An authorization request is originated from the POS terminal and routed via an acquiring financial institution to a token service provider. The authorization request includes the token and other information, including an indication that the transaction was initiated via an NFC read at the point of sale.

The token service provider maintains a secure database (or “vault”) that maps tokens to associated PANs. The token service provider notes that the token in the authorization request is intended for use only in NFC transactions at the point of sale, so that this use of the token is authorized. Accordingly, the token service provider replaces the token with the corresponding PAN that the token represents and then routes the authorization request (including the PAN and other information) to the issuer of the payment card account identified by the PAN.

In this use case, the token itself is of relatively little value to a wrongdoer. If the token were—for instance—embodied into a counterfeit magnetic stripe payment card, such a card would fail to be usable in a transaction, because the token would be rejected if presented in a mag stripe “swipe” transaction, or indeed in any other type of transaction that is not initiated via NFC at point of sale. It also is quite unlikely that the wrongdoer would have the technological resources needed to load the token (if it were stolen) into a payment-enabled NFC-capable mobile device.

In addition to the above described use case involving presentation of a payment token via NFC communication at the point of sale, other use cases are contemplated by the Payment Token Interoperability Standard. For example, a payment token may be stored with an e-commerce merchant in a “card-on-file” arrangement, and may be submitted by the merchant via the merchant's acquiring financial institution in response to an online purchase transaction initiated with the merchant by the payment card account holder.

In another example use case, a payment token may be presented at point of sale by having a QR (Quick Response) code displayed by a mobile device and scanned by the point of sale terminal.

Other payment token use cases are also contemplated by the Payment Token Interoperability Standard.

As recognized in the Payment Token Interoperability Standard and in other contexts, so-called lifecycle events are likely to occur from time to time with respect to the token-provisioned mobile device, or in connection with other deployments of payment tokens. Examples of lifecycle events may range from updating of an expiration date for the token to the user's changing of his/her underlying payment card account or even loss or theft of the mobile device itself.

According to a conventional proposal for at least some lifecycle events, a secure element (SE) in the mobile device may be updated with relevant data via APDU (application protocol data unit) commands. However, such an update may involve considerable effort and inconvenience on the part of both the account issuer and the user of the mobile device, e.g., to arrange for establishment of a proper communication channel from an issuer-controlled device to the mobile device.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a system in which teachings of the present disclosure may be applied.

FIG. 2 is a block diagram representation of an arrangement in accordance with this disclosure for an advantageous manner of responding to lifecycle events relating to a token-provisioned payment-enabled mobile device.

FIG. 3 is a block diagram representation of a computer system that may perform at least some functions in accordance with aspects of the present disclosure

FIG. 4 is a flow chart that illustrates aspects of the present disclosure, including a portion of the operations of the computer system of FIG. 3.

FIGS. 5-8 are flow charts that illustrate details of the process of FIG. 4 according to various use cases that may be handled by the computer system of FIG. 3.

### DETAILED DESCRIPTION

In general, and for the purpose of introducing concepts of the present disclosure, a token service provider maintains a secure database (also referred to as a “token vault”) to enable mapping of tokens to PANs. The database stores entries for tokens issued by the token service provider. In many cases, these tokens may have been provisioned to mobile devices used for initiating payment transactions. When a lifecycle event occurs (or is about to occur) for a token, at least in some cases the token service provider and/or account issuer may respond by updating the database entry for the token rather than engaging in an update process with the mobile device. This approach may minimize costs and inconvenience for the payment card account issuer in dealing with lifecycle events.

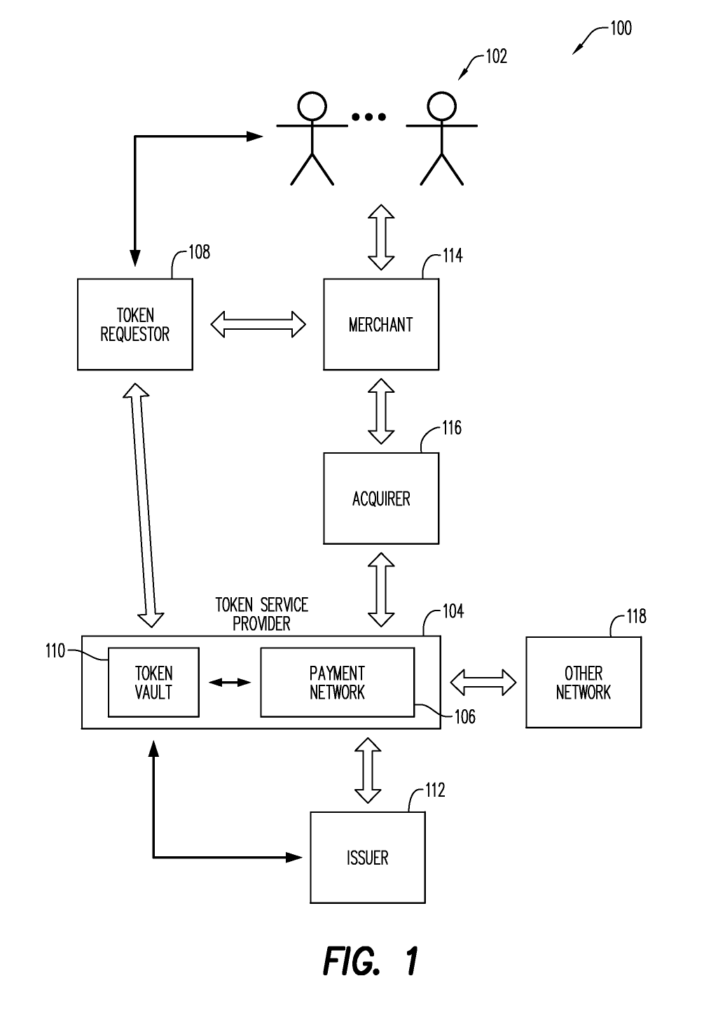

FIG. 1 is a block diagram that illustrates a system 100 in which teachings of the present disclosure may be applied. (FIG. 1 is adapted from the “FIG. 1” presented on page 10 of the above-mentioned Payment Token Interoperability Standard.)

Individual users/cardholders are indicated by reference numeral 102 in FIG. 1. As is familiar to the reader, the vast majority of the users 102 may habitually carry with them mobile devices such as smartphones, tablet computers, or the like. (To simplify the drawing, these devices are not explicitly shown.) It is assumed that many of the mobile devices may be provisioned with respective tokens, in accordance with the above-described use case from the Payment Token Interoperability Standard.

FIG. 1 also includes a block 104 that represents a token service provider. The token service provider 104 may in some embodiments also be the operator of a payment network (block 106), such as the well-known Banknet® system operated by MasterCard International Incorporated, the assignee hereof. The token service provider 104 may be authorized in the system 100 to issue tokens. The tokens may be issued to token requestors such as the token requestor represented by block 108 in FIG. 1. (As set forth in the Payment Token Interoperability Standard, token requestors may, for example, include payment card account issuers; card-on-file merchants; acquirers, acquirer-processors, etc.; OEM device manufacturers; and digital wallet providers). Each token requestor 108 may be required to register with the token service provider 104.

In issuing tokens, the token service provider 104 may perform such functions as operating and maintaining a token vault 110, generating and issuing tokens (in accordance, e.g., with aspects of the present disclosure), assuring security and proper controls, token provisioning (e.g., provisioning NFC-capable mobile devices with token values; personalizing payment cards with token values), and registering token requestors.

In addition to representing the token service provider, block 104 should also be understood to represent one or more computer systems operated by the token service provider.

Block 112 in FIG. 1 represents an issuer of payment card accounts held by the cardholders 102. Those who are skilled in the art will understand that the issuer is typically a bank or other financial institution, and may provide banking services to the cardholders 102 in addition to issuing payment card accounts (e.g., credit card accounts, debit card accounts) to the cardholders 102. It was noted above that issuers 112 may also have the role of token requestor (block 108) in the system 100. In accordance with some teachings of the present disclosure, the token service provider 104 may assist or perform additional services for issuers 112 in connection with token lifecycle events.

Block 114 in FIG. 1 represents a merchant to which the cardholders 102 may present payment devices (payment cards and/or payment-enabled mobile devices—e.g., NFC-enabled and token-provisioned mobile devices, etc., none of which are shown in the drawing) to consummate a purchase transaction. In some cases the merchant 114 may also be a token requestor 108 (e.g., for implementing a tokenized card-on-file arrangement for e-commerce transactions with a cardholder 102). According to previously proposed use cases, the merchant may receive a token value from a cardholder's payment device and issue an authorization request to initiate processing of a payment transaction in the system 100.

Block 116 in FIG. 1 represents an acquirer. As is well known, the acquirer may be a financial institution that provides banking services to the merchant 114, and that receives and routes payment transaction authorization requests originated from the merchant 114.

Also shown in FIG. 1 is a block 118, representing another payment network with which the token service provider 104 may interact.

It will be readily appreciated that a practical embodiment of the system 100 may include numerous merchants, token requestors, acquirers and issuers, rather than one of each as depicted in FIG. 1. It may also be the case that there is more than one token service provider in the system.

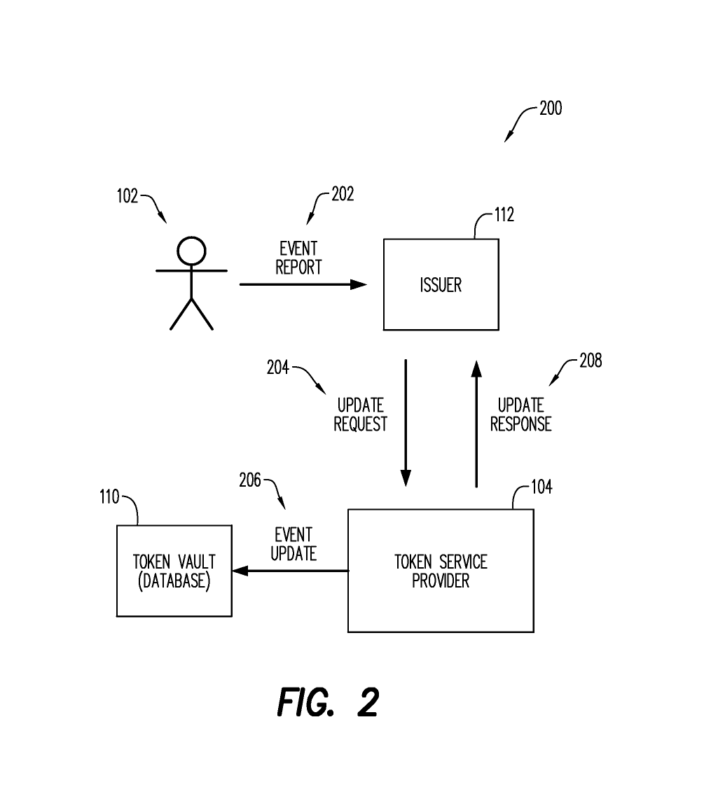

FIG. 2 is a block diagram representation of an arrangement 200 in accordance with this disclosure for an advantageous manner of responding to lifecycle events relating to a token-provisioned payment-enabled mobile device. The lifecycle event response arrangement 200 may be constituted by a number of entities that were introduced above in the description of FIG. 1; namely, a user/cardholder 102, an issuer 112, the token service provider 104 and the token vault 110. In some cases, a lifecycle event may become known in the arrangement 200 based on an event report (e.g., lost or stolen mobile device) provided from the cardholder 102 to the issuer 112. (Reference numeral 202 in FIG. 2 indicates the event report.) In some cases, either in response to an event report 202 or on its own initiative, the issuer 112 may send a database update request (reference numeral 204) to the token service provider 104. As indicated at 206, either on its own initiative or following the database update request 204, the token service provider 104 may engage in a token entry update operation 206 to update one of the token entries maintained in the token vault 110. If the token entry update operation 206 followed a database update request 204 from the issuer 112, then the token service provider 104 may follow up the token entry update operation 206 with an update response (reference numeral 208) to the issuer 112 to confirm that the token entry update operation 206 has occurred.

In some cases, the issuer 112, as a trusted entity, may effectively have quasi-direct access to the token vault 110. In other conceptual terms, the token vault 110 and block 104 may both be viewed as part of a computer system maintained by the token service provider and responsive to requests from the issuer 112. It will be recognized that block 112 may represent a computer system operated by or on behalf of the issuer.

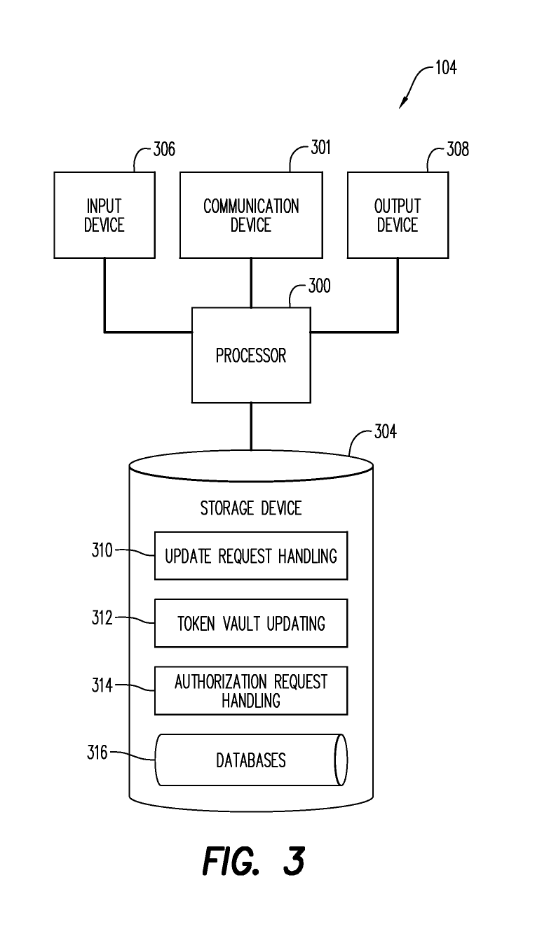

FIG. 3 is a block diagram representation of a computer system that may be operated by the token service provider in accordance with aspects of the present disclosure. This computer system, indicated by reference numeral 104, may be referred to as the “token service provider computer 104” and may perform at least some functions in accordance with aspects of the present disclosure.

The token service provider computer 104 may be conventional in its hardware aspects but may be controlled by software to cause it to function as described herein. For example, the token service provider computer 104 may be constituted by conventional server computer hardware. In some embodiments, functionality disclosed herein may be distributed among two or more computers having hardware architecture similar to that described below.

The token service provider computer 104 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the token service provider computer 104 to provide desired functionality.

Communication device 301 may be used to facilitate communication with, for example, other devices (such as other components of the system 100 shown in FIG. 1). For example (and continuing to refer to FIG. 3), communication device 301 may comprise numerous communication ports (not separately shown), to allow the token service provider computer 104 to communicate simultaneously with a number of other computers and other devices, including computers operated by issuers, acquirers and token requestors.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the token service provider computer 104, executed by the processor 300 to cause the token service provider computer 104 to function as described herein.

The programs may include one or more conventional operating systems (not shown) that control the processor 300 so as to manage and coordinate activities and sharing of resources in the token service provider computer 104, and to serve as a host for application programs (described below) that run on the token service provider computer 104.

The programs stored in the storage device 304 may also include an update request handling program 310 that may control the processor 300 to enable the token service provider computer 104 to receive and respond to the database update requests (from the issuer 112) as shown at 204 in FIG. 2. In addition, and continuing to refer to FIG. 3, the storage device 304 may store a token vault updating program 312 that may control the token service provider computer 104 to implement token entry update operations as shown at 206 in FIG. 2. Still further, and again referring to FIG. 3, the storage device 304 may store an authorization request handling program 314. The authorization request handling program 314 may control the processor 300 to enable the token service provider computer 104 to perform necessary functions with respect to authorization requests received from acquirers, such as the acquirer represented at 116 in FIG. 1. In this regard, it should be noted that the computer hardware constituting the token service provider computer 104 may overlap or coincide with computer hardware operated by a payment system to generally handle and route payment transaction authorization requests. Accordingly, in addition to functionality provided in accordance with teachings of this disclosure, the authorization request handling program 314 may provide conventional functionality for handling and routing payment transaction authorization requests in a payment system that implements tokenization. Still further, and in accordance with teachings of the present disclosure, the authorization request handling program 314 may provide functionality to carry into effect lifecycle-related updating of the token vault 110 (FIGS. 1 and 2).

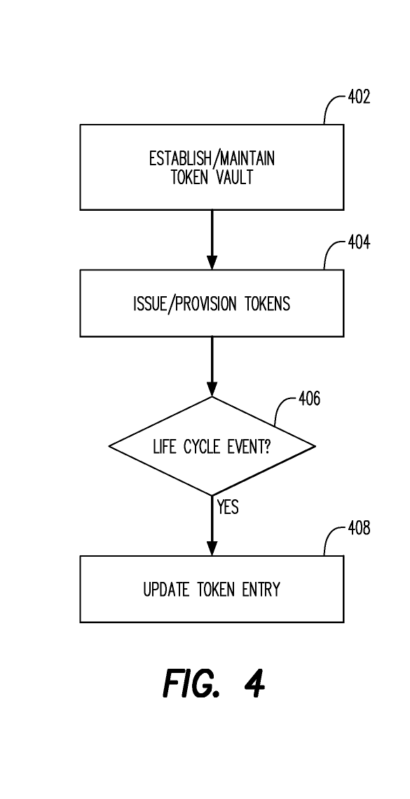

Further details concerning functionality provided by the programs 310, 312 and 314 will be described below in the description of the processes illustrated in FIGS. 4-8.

Continuing to refer to FIG. 3, the storage device 304 may also store, and the token service provider computer 104 may also execute, other programs, which are not shown. For example, such programs may include a reporting application, which may respond to requests from system administrators for reports on the activities performed by the token service provider computer 104. The other programs may also include, e.g., device drivers, etc.

The storage device 304 may also store one or more databases 316 required for operation of the token service provider computer 104. Such databases may include the above-mentioned token vault 110.

FIG. 4 is a flow chart that illustrates aspects of the present disclosure, including a portion of the operations of the token service provider computer 104.

At 402 in FIG. 4, the token vault 110 is established in, or in association with, the token service provider computer 104. As noted above, a main purpose of the token vault 110 is to provide for mapping of tokens to corresponding PANs. For this purpose each token that has been put into use (e.g., that has been provisioned to a payment-enabled mobile device) may be represented in the token vault 110 by a respective database entry for the token in question. In each such entry, the corresponding PAN may also be stored, along with other data, such as expiration dates for the token and for the corresponding PAN. In addition, the entry for the token may indicate the authorized mode and/or channel by which the token may be presented for use in a payment transaction. In the case of a token that has been provisioned to an NFC-capable payment-enabled mobile device, the indicated authorized mode/channel would be NFC at point of sale.

Once the token vault 110 is established, the token service provider computer 104 may provide the functionality required to maintain the token vault 110, including all required security measures, keeping the data current and accessible, responding to requests and inquiries from authorized entities, etc.

At 404, the token service provider computer 104 may issue tokens and/or provision the same to, e.g., payment-enabled mobile devices. In this regard, the token service provider computer 104 may in some cases act on behalf of the issuer for the underlying payment card accounts. In other cases, the token service provider computer 104 may only provide the tokens to the issuer(s), and the issuers may undertake the logistical tasks involved in provisioning the tokens to the cardholder's device (which may be a payment-enabled mobile device, a payment card, etc.)

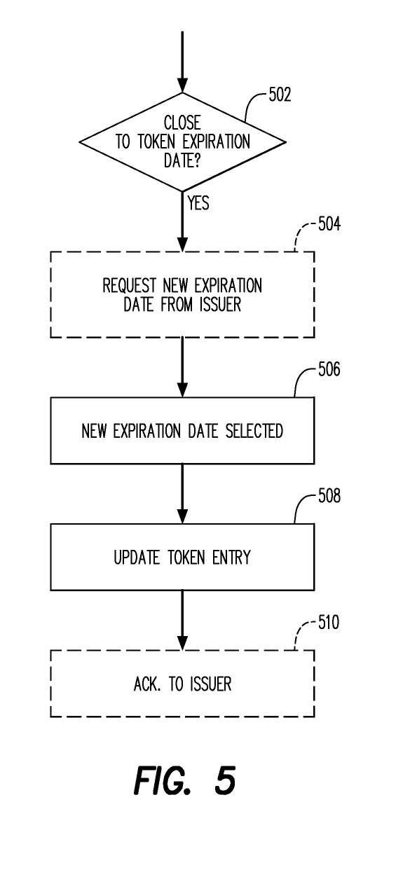

At decision block 406, it is determined whether a lifecycle event has occurred for a particular token for which there is an entry in the token vault 110. Various use cases, corresponding to various different kinds of lifecycle events, are described below with reference to FIGS. 5-8. Some example lifecycle events may include occurrence or approaching occurrence of a token expiration date, a change in a token or a PAN associated with a token, occurrence or approaching occurrence of a PAN expiration date, a report of loss or theft of a mobile device to which a token has been provisioned, etc.

If a positive determination is made at 406 (i.e., if it is determined that a lifecycle event has occurred or is soon to occur for a token), then block 408 may follow decision block 406. At block 408, the entry in the token vault 110 for the token in question may be updated in a manner that is responsive to the lifecycle event for the token. In at least some cases, the nature of the update to the entry for the token may make it unnecessary to engage in an update to the secure element in the mobile device to which the token in question had been provisioned.

A number of use case examples providing details of the process of FIG. 4 will now be described, initially with reference to FIG. 5.

FIG. 5 is a flow chart that illustrates a use case example for a lifecycle event in which the token expiration date is approaching. At decision block 502 in FIG. 5, it is determined whether the current point in time is close to the expiration date for a token currently provisioned to a mobile device. For present purposes, a time may be considered close to the expiration date (and the expiration date may be considered to be approaching) if the current time is within a predetermined time prior to the expiration date—e.g., within a timeframe such as one in which plastic payment cards are customarily reissued with a new expiration date prior to the expiration date shown on the existing card. Other timeframes are possible. For example, in some cases a timeframe of one month before the expiration date may be set. Any or all of these examples may be considered to be cases in which a lifecycle event will soon occur.

In some cases, the token service provider computer 104 may regularly scan all the token expiration dates in the token vault 110 to find expiration dates that are approaching. In addition or alternatively, the issuer for the corresponding PANs may have the role of detecting this lifecycle event for tokens issued at its request. The issuer may perform this function by access to the token vault 110 and/or by reference to a separate database maintained by the issuer and showing expiration dates for tokens mapped to PANs for payment card accounts that it has issued.

In some cases block 504 may follow a positive determination at decision block 502. At block 504, the token service provider computer 104 may request the issuer to provide a new (updated) expiration date for the token in question. In other cases block 504 may not be required because, e.g.—(a) the issuer itself detected the approaching expiration date and proactively supplied a new expiration date to the token service provider computer 104; or (b) based on a standing arrangement with the issuer, the token service provider computer 104 is authorized to automatically increment the expiration date by a predetermined amount of time (say one or two years) when the expiration date is approaching.

In any case, whether based on a response from the issuer or on the initiative of the token service provider computer 104 itself, a new expiration date for the token may be selected, as indicated at 506 in FIG. 5.

Then, at block 508, the token service provider computer 104 carries out an update operation to the database entry for the token in question to replace the existing token expiration date in the database entry with the new token expiration date selected at 506.

In some cases, block 510 may follow 508. For example, if the token entry update operation of block 508 occurred at the request of the issuer, then the token service provider computer 104 may provide an acknowledgment/response message to the issuer as per block 510 to confirm that the requested update has occurred.

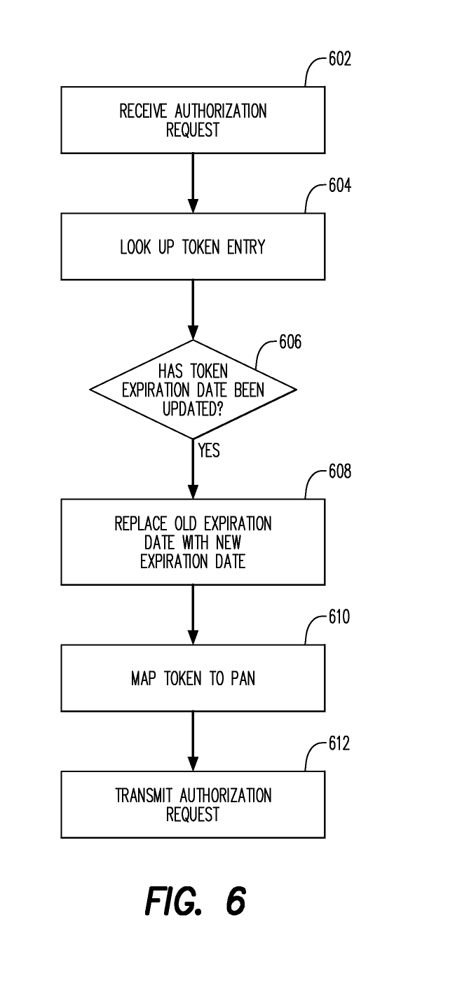

FIG. 6 is a flow chart that illustrates a process whereby the updating of the token expiration date via the token vault 110 may be put into practical effect via handling of an authorization request by the token service provider computer 104.

At 602 in FIG. 6, the token service provider computer 104 receives a payment transaction authorization request for “de-tokenization” (within the meaning ascribed to that term in Table 2 of the Payment Token Interoperability Standard). It will be appreciated by those who are skilled in the art that the authorization request in question contains a token that is to be mapped to the PAN which the token represents. The authorization request would also contain an expiration date for the token, as communicated to the merchant from the payment device at the point of sale. At 604, the token service provider computer 104 looks up the entry in the token vault 110 for the token included in the authorization request.

Decision block 606 may follow block 604. At decision block 606, the token service provider computer 104 may determine whether, in effect, the expiration date for the token has been updated (in a process such as that illustrated in FIG. 5); that is, the token service provider computer 104 may determine whether the expiration date of the token, as contained in the entry for the token in the token vault 110, is later than the token expiration date as contained in the authorization request. If so, then block 608 may follow decision block 606. At block 608, the token service provider computer 104 may replace the (old/obsolete) token expiration date as contained in the authorization request with the updated token expiration date that had been stored in the token vault entry for the token in question.

At 610, the token service provider computer 104 maps the token to the PAN listed in the entry in the token vault 110 for the token. At 612, and in accordance with use cases as contained in the Payment Token Interoperability Standard, the token service provider computer 104 may transmit the authorization request for routing to the issuer of the payment card account represented by the PAN to which the token was mapped. As called for by the Payment Token Interoperability Standard, the authorization request as transmitted by the token service provider computer 104 may include the PAN and its expiration date, as looked up from the token vault 110, and also the token, as received by the token service provider computer 104. In an aspect that goes beyond the Payment Token Interoperability Standard, the authorization request as transmitted at 612 may include the updated token expiration date from the token vault 110 in place of the obsolete token expiration date contained in the authorization request when it was received by the token service provider computer 104. Assuming that the system does not perform any other check of the token expiration date until after the process of FIG. 6 (e.g., assuming that only the issuer performs an authorize/reject check of the token expiration date), then the updating of the token expiration in the token vault 110 (together with substitution of the updated token expiration date for the obsolete token expiration date when the token service provider computer 104 handles an authorization request) can have the effect of satisfactorily responding to this lifecycle event without the effort and inconvenience of re-provisioning a new token expiration date to the mobile device carried by the cardholder.

It is thus assumed for present purposes that any token cryptogram or the like provided at point of sale by the mobile device does not reflect the token expiration date as stored in the mobile device.

Referring again to the process of FIG. 6, those who are skilled in the art will understand that, in situations where replacement of the token expiration date need not occur, the mapping of the token to the PAN and the transmission of the authorization request may go forward without the operations described in connection with block 608.

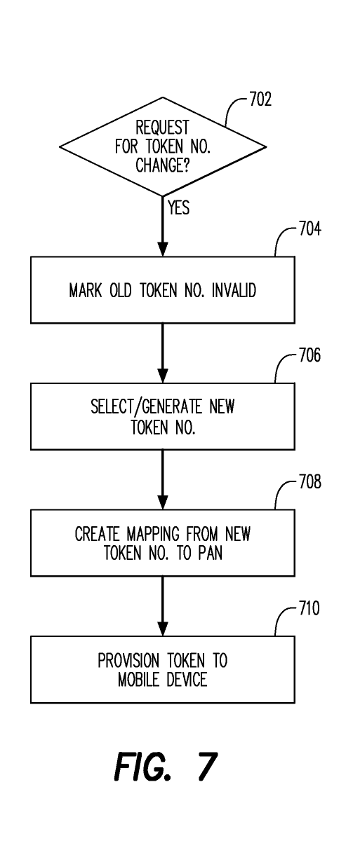

Turning now to FIG. 7, the process illustrated therein corresponds to lifecycle use cases in which it is necessary or desirable to change a token that has previously been provisioned to a payment-enabled mobile device. This may occur, for example, on a routine basis at the issuer's request. Alternatively, this may occur if the user has reported that his/her payment-enabled mobile device, in which the token had been provisioned, has been lost or stolen. In any event, at decision block 702 in FIG. 7, it is determined whether a change in the token number has been requested. If a positive determination is made at 702, then block 704 may follow decision block 702. At block 704, the token service provider computer 104 may make a notation in the token vault entry for the token that is being replaced to indicate that this old token number is no longer valid.

Block 706 may follow block 704. At block 706, the token service provider computer 104 may select or generate a new token number in a conventional manner.

Block 708 may follow block 706. At block 708, the token service provider computer 104 may establish or update a database entry for the token number selected or generated at 706, such that the new token number is mapped to the same PAN to which the replaced token number was previously mapped. In addition, the database entry for the new token number may be caused to contain other data necessary to effectuate mapping of the new token to the PAN.

Block 710 may follow block 708. At block 710, the token service provider computer 104 (or in some cases the payment account issuer) may provision the new token to the user's payment-enabled mobile device. In the course of the provisioning of the new token to the mobile device, other data may also be provisioned to the mobile device, including, for example, a token expiration date for the new token, an updated cryptographic key or keys, etc.

Although not shown in the drawing, the process of FIG. 7 may also include the token service provider computer 104 providing an acknowledgment message to the issuer to confirm that the requested replacement of the token has occurred.

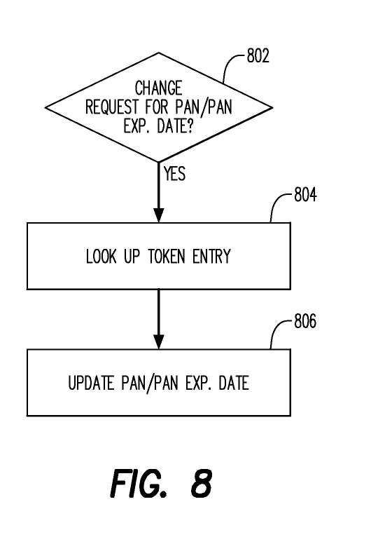

Referring now to FIG. 8, the process shown in that drawing corresponds to a lifecycle event in which the PAN and/or the expiration date for the PAN is to be changed. (It should be understood that the PAN referred to in the previous sentence is the one to which a provisioned token is mapped in the token vault.) This lifecycle event may occur routinely, or in response to the user electing to change his/her payment card account, or because the user has reported to the issuer that a payment card or other device that contains the PAN has been lost or stolen, or because the PAN has been compromised in some other way (such as by a data breach at a merchant). In the case of replacement of the expiration date for a PAN, this may occur when the current expiration date is approaching. Accordingly, at decision block 802 in FIG. 8, it is determined whether a change in the PAN (or in the PAN expiration date) is requested. It will be noted that the request for this change may come from the payment account issuer.

If a positive determination is made at 802, then block 804 may follow block 802. At block 804, the token service provider computer 104 may look up the database entry for one or more tokens that are mapped to the PAN or PAN expiration date that is to be changed.

Block 806 may follow block 804. At block 806, the token service provider computer 104 may update the PAN and/or the PAN expiration date, as the case may be, in the database entry or entries that it looked up at 704. As a result the token(s) in question is (are) now remapped to the new PAN (if the PAN has been changed).

It will be appreciated that the above-described use cases relating to handling of payment token life cycle events can be readily adapted and applied to deployment of payment tokens by various means, including, but not limited to, provisioning of payment tokens to payment enabled mobile devices, card-on-file arrangements, and other manners of deploying payment tokens that are already known to those who are skilled in the art or that may hereafter be proposed.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
maintaining a token database in a computer system, the token database for mapping tokens to primary account numbers (PANs) for payment card accounts;
storing a respective entry in the token database for a token, the token mapped by the respective entry to a respective PAN, the respective PAN identifying a payment card account that belongs to a cardholder who uses a mobile device;
provisioning the token to the mobile device;
determining that a lifecycle event has occurred or will soon occur with respect to the token; and
updating the respective entry for the token in the token database in response to determining that the lifecycle event has occurred.

2. The method of claim 1, wherein:
the lifecycle event is an expiration date for the token; and
the updating step includes updating the expiration date for the token in the respective entry for the token in the token database.

3. The method of claim 2, wherein the updated token expiration date is not provisioned to the mobile device.

4. The method of claim 1, wherein:
the lifecycle event is loss of the mobile device; and
the updating step includes indicating that the token is no longer valid.

5. The method of claim 4, further comprising:
mapping a new token to the respective PAN.

6. The method of claim 5, further comprising:
provisioning the new token to a new mobile device for the cardholder.

7. The method of claim 1, wherein:
the lifecycle event is replacement of the respective PAN associated with the token; and
the updating step includes mapping the token to a replacement PAN instead of the respective PAN.

8. The method of claim 1, wherein:
the lifecycle event is loss of a payment card that carries the respective PAN; and
the updating step includes mapping the token to a replacement PAN instead of the respective PAN.

9. The method of claim 1, wherein:
the lifecycle event is replacement of the token; and
the updating step includes indicating that the token is no longer valid;
and the method further comprising:
mapping a new token to the respective PAN.

10. The method of claim 9, further comprising:
provisioning the new token to the mobile device.

11. The method of claim 1, wherein:
the lifecycle event is an expiration date for the respective PAN; and
the updating step includes updating the expiration date for the respective PAN in the respective entry for the token.

12. A method comprising:
receiving, in a computer system, an authorization request for a payment transaction, the authorization request including a token and an obsolete expiration date for the token;
accessing an entry for the token in a token database to look up a current expiration date for the token;
replacing the obsolete expiration date with the looked-up current expiration date; and
transmitting, from the computer system, the authorization request with the current expiration date.

13. The method of claim 12, further comprising, after the receiving step and before the transmitting step:
looking up in the token database a respective primary account number (PAN) to which the token is mapped; and
inserting the looked-up PAN into the authorization request.

14. The method of claim 13, wherein the transmitting step includes:
using the looked-up PAN to route the authorization request to an issuer of a payment card account indicated by the looked-up PAN.

15. An apparatus comprising:
a processor; and
a memory in communication with the processor, the memory storing program instructions, the program instructions controlling the processor to perform operations as follows:
maintaining a token database in a computer system, the token database for mapping tokens to primary account numbers (PANs) for payment card accounts;
storing a respective entry in the token database for a token, the token mapped by the respective entry to a respective PAN, the respective PAN identifying a payment card account that belongs to a cardholder who uses a mobile device;
provisioning the token to the mobile device;
determining that a lifecycle event has occurred or will soon occur with respect to the token; and
updating the respective entry for the token in the token database in response to determining that the lifecycle event has occurred.

16. The apparatus of claim 15, wherein:
the lifecycle event is an expiration date for the token; and
the updating operation includes updating the expiration date for the token in the respective entry for the token in the token database.

17. The apparatus of claim 16, wherein the updated token expiration date is not provisioned to the mobile device.

18. The apparatus of claim 15, wherein:
the lifecycle event is loss of the mobile device; and
the updating operation includes indicating that the token is no longer valid.

19. The apparatus of claim 18, wherein the processor is further operative to map a new token to the respective PAN.

20. The apparatus of claim 15, wherein:
the lifecycle event is replacement of the respective PAN associated with the token; and
the updating operation includes mapping the token to a replacement PAN instead of the respective PAN.
